(19) United States
(12) Patent Application Publication
(10) Pub. No.: US 2025/0350043 A1
(43) Pub. Date: Nov. 13, 2025

(54) CONNECTION BODY AND METHOD FOR CONNECTING CONNECTION BODY

(71) Applicant: JAPAN AVIATION ELECTRONICS INDUSTRY, LIMITED, Tokyo (JP)

(72) Inventor: Kenta ASHIBU, Tokyo (JP)

(73) Assignee: JAPAN AVIATION ELECTRONICS INDUSTRY, LIMITED, Tokyo (JP)

(21) Appl. No.: 19/070,763

(22) Filed: Mar. 5, 2025

(30) Foreign Application Priority Data
May 13, 2024 (JP) 2024-077892

(51) Int. Cl. H01R 4/34; H01R 13/512; H01R 13/52; H01R 43/20

(52) U.S. Cl. CPC H01R 4/34; H01R 13/512; H01R 13/5202; H01R 43/20

(57) ABSTRACT

A second bolt insertion portion and a third bolt insertion portion have a following positional relationship in a connection body. The positional relationship is a positional relationship which allows fastening by insertion of a single bolt in a state in which base portions of a pair of first terminals are inserted into respective second cutout portions, a pair of second terminals are mounted on respective end portions of first contact portions, and a pair of first pressing portions are mounted on respective end portions of second contact portions. The fastening makes the first contact portions and the respective second contact portions conductive.

### TECHNICAL FIELD

The present disclosure relates to a connection structure of a connection body.

### BACKGROUND ART

As a conventional technology for connector assemblies, for example, Japanese Patent Application Laid Open No. 2024-4140 (hereinafter, referred to as “Patent Literature 1”) discloses a connector assembly that reduces a manufacturing cost and size by simplifying the structure thereof. FIGS. 1 and 2 illustrate a structure of a connector assembly of a prior art. In the connector assembly of FIGS. 1 and 2, a connector assembly 10 includes a first connector 12 and a second connector 14. The first connector 12 includes: a first terminal metal fitting 16 protruded outward from a metal casing 20; and a metal hood portion 22 protruded from the casing 20 in a manner surrounding the first terminal metal fitting 16. The second connector 14 includes: a second terminal metal fitting 18 connected with the first terminal metal fitting 16; an insulative housing 74 that accommodates the second terminal metal fitting 18; and a metal flat plate portion 76 arranged fixedly on an outer surface side of the housing 74. In a state where the first connector 12 and the second connector 14 are fitted to each other, the housing 74 of the second connector 14 is housed and arranged in the hood portion 22 of the first connector 12, and a contact portion 156 of the flat plate portion 76 is placed on and connected with a protruded end surface 64 of the hood portion 22, the flat plate portion 76 covering a protruded side opening 58 of the hood portion 22.

### SUMMARY OF THE INVENTION

In the connector assembly of Patent Literature 1, in the state in which the first connector 12 and the second connector 14 are fitted to each other, a fastening bolt 190 is inserted to fix the first connector 12 and the second connector 14 to each other (paragraph 0074). Further, in the connector assembly, conduction between the first connector 12 and the second connector 14 is achieved by making each first terminal metal fitting 16 and each second terminal metal fitting 18 electrically conductive (paragraph 0073). The second terminal metal fitting 18 is configured to include a second terminal metal fitting body 86 and a clip spring 88 serving as an elastic member attached to a tip portion (front end portion) of the second terminal metal fitting body 86 (paragraph 0040). That is, the connector assembly of Patent Literature 1 employs the configuration in which fitting is achieved by inserting the fastening bolt 190 and conduction is achieved with the clip spring 88, accordingly having problems in that the number of components increases and contact strength is insufficient, for example, as a connection structure for large currents.

An object of the present disclosure is to provide a connection body which suppresses increase in the number of components and enables connection that can withstand large currents.

To solve the above-described problems, a connection body according to the present embodiment includes: a first insulating plate which has a pair of second cutout portions formed on both ends and a second bolt insertion portion formed between the pair of second cutout portions; a pair of first terminals which have base portions having flat plate shapes to be able to be inserted into the second cutout portions, and first contact portions, the first contact portions being connected with one ends of the base portions in a longitudinal direction and having flat plate shapes extended to have a width, the width being greater than a width of the second cutout portions, on both sides in a width direction of the base portions; a pair of second terminals which have second contact portions having flat plate shapes to be able to be mounted on end portions, the end portions being on an opposite side to the base portions, of the first contact portions in the pair of first terminals; and a second insulating plate which has a pair of first pressing portions being able to be mounted on surfaces, the surfaces being on an opposite side to the first terminals, of the second contact portions in the pair of second terminals, a first coupling portion coupling the pair of first pressing portions, and a third bolt insertion portion formed in the first coupling portion. A positional relationship between the second bolt insertion portion and the third bolt insertion portion is a positional relationship which allows fastening by insertion of a single bolt in a state in which the base portions of the first terminals are inserted into the respective second cutout portions, the second terminals are mounted on the respective end portions of the first contact portions, and the first pressing portions are mounted on respective end portions of the second contact portions, and the fastening makes the first contact portions and the respective second contact portions conductive.

### Effects of the Invention

According to the connection body of the present embodiment, increase in the number of components can be suppressed and connection that can withstand large currents can be achieved.

### BRIEF DESCRIPTION OF THE DRAWINGS

FIG. 1 illustrates a connector assembly of a prior art.

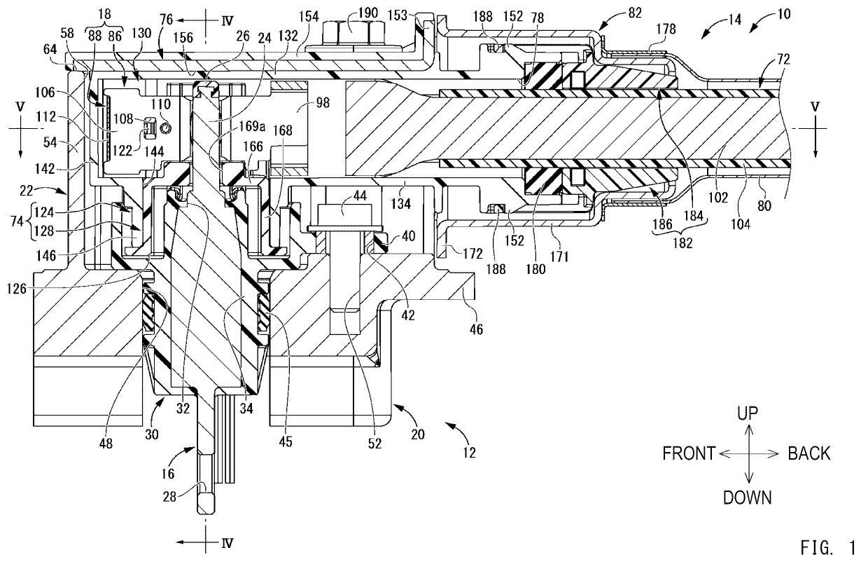

FIG. 2 illustrates the connector assembly of the prior art.

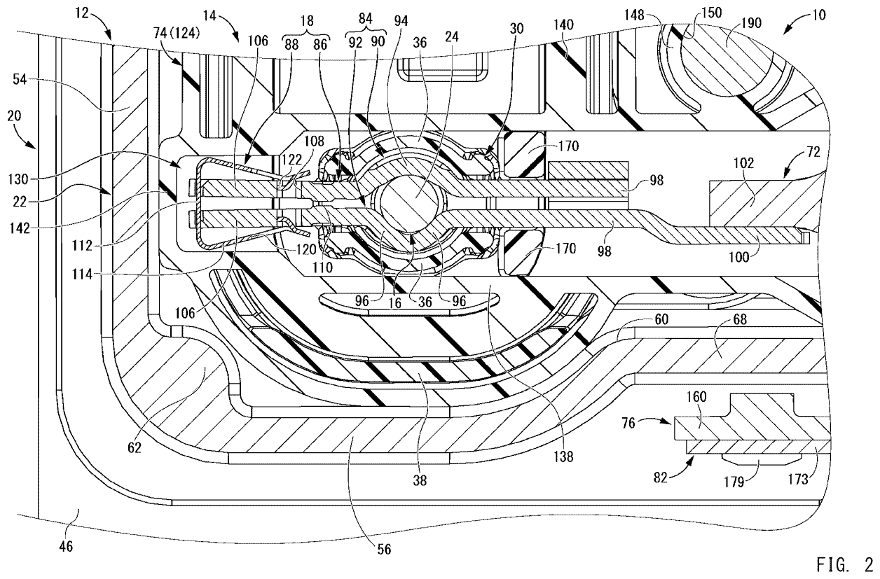

FIG. 3 illustrates an example of a connection body according to a first embodiment, where (a) is a perspective view, (b) is a plan view, and (c) is a left side view.

FIG. 4 is an exploded perspective view of a connection body 1A.

FIG. 5 is a sectional view taken along a K-K line in FIG. 3.

FIG. 6 is a sectional view taken along an L-L line in FIG. 3.

FIG. 7 is a sectional view taken along an I-I line in FIG. 3.

FIG. 8 illustrates a header 2A, where (a) is a perspective view, (b) is a plan view, and (c) is a left side view.

FIG. 9 is a sectional view taken along an F-F line in FIG. 8.

FIG. 10 illustrates a first housing 10A, where (a) is a plan view, (b) is a sectional view taken along a Q-Q line in (a), (c) is a sectional view taken along an R-R line in (a), and (d) is a sectional view taken along a P-P line in (a).

FIG. 11 illustrates a plug harness 3A, where (a) is a plan view, (b) is a left side view, and (c) is a bottom surface view.

FIG. 12 illustrates a second housing 50A, where (a) is a plan view, (b) is a sectional view taken along an N-N line in (a), (c) is a sectional view taken along an O-O line in (a), and (d) is a sectional view taken along an M-M line in (a).

FIG. 13 illustrates an example of a connection body according to a second embodiment, where (a) is a perspective view, (b) is a plan view, and (c) is a left side view.

FIG. 14 illustrates a connection body 1B, where (a) is a bottom surface view, (b) is an elevational view, and (c) is a sectional view taken along a B-B line in FIG. 13.

FIG. 15 illustrates the connection body 1B, where (a) is a sectional view taken along a J-J line in FIG. 13, and (b) is a sectional view taken along an A-A line in FIG. 13.

FIG. 16 is an exploded perspective view of the connection body 1B.

### DETAILED DESCRIPTION OF THE EMBODIMENTS

### First Embodiment

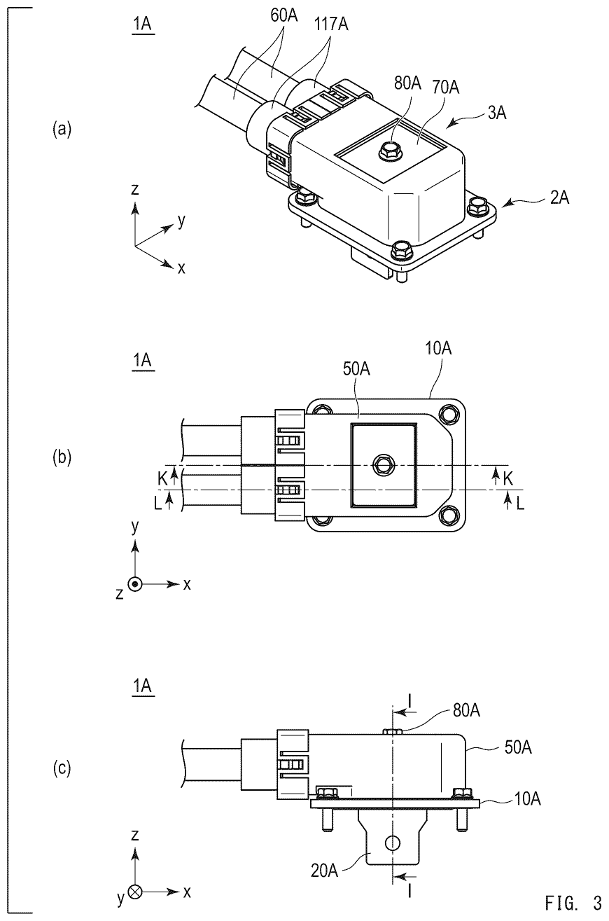

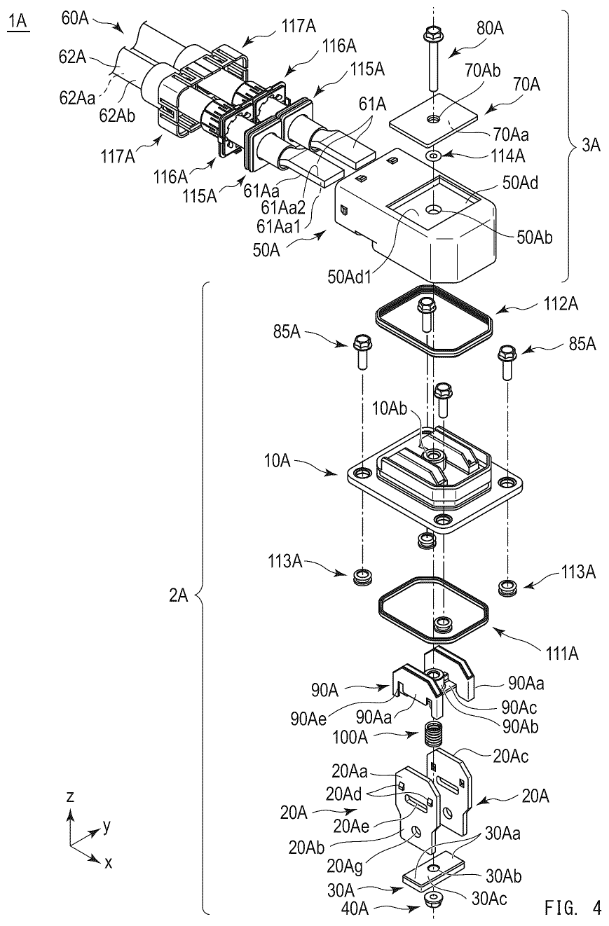

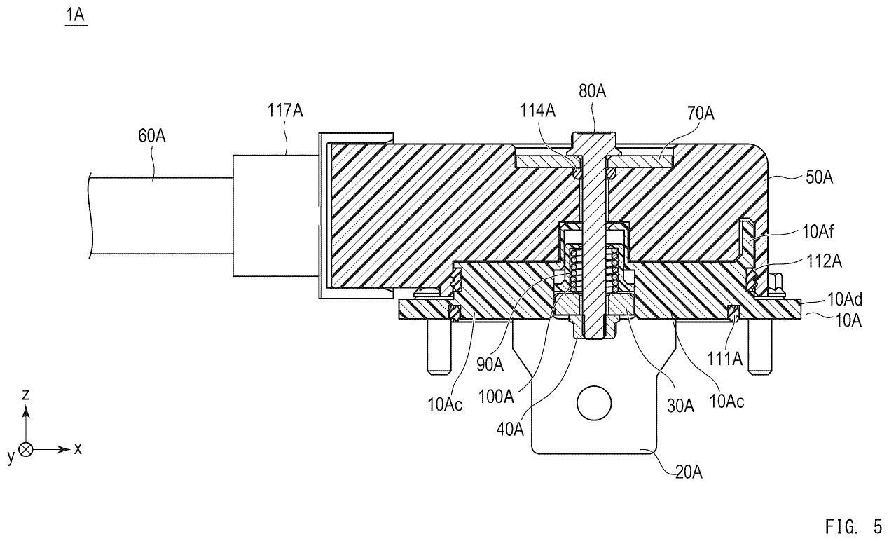

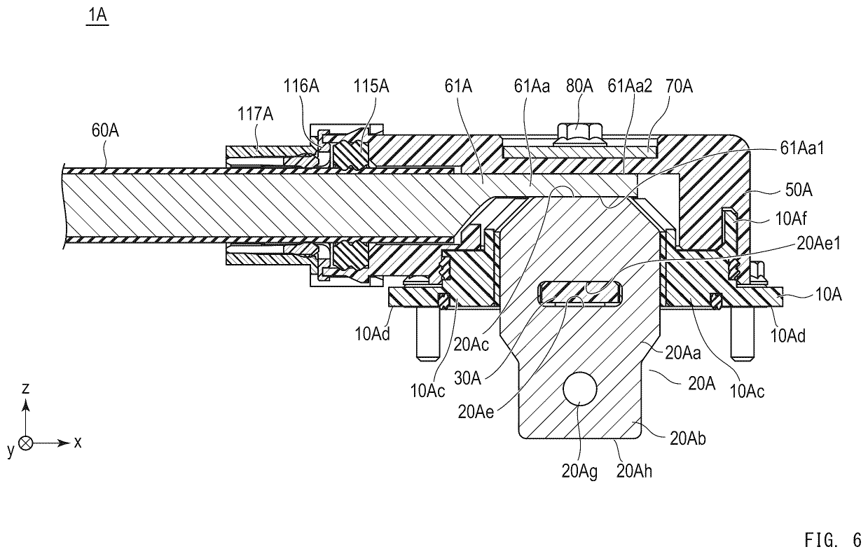

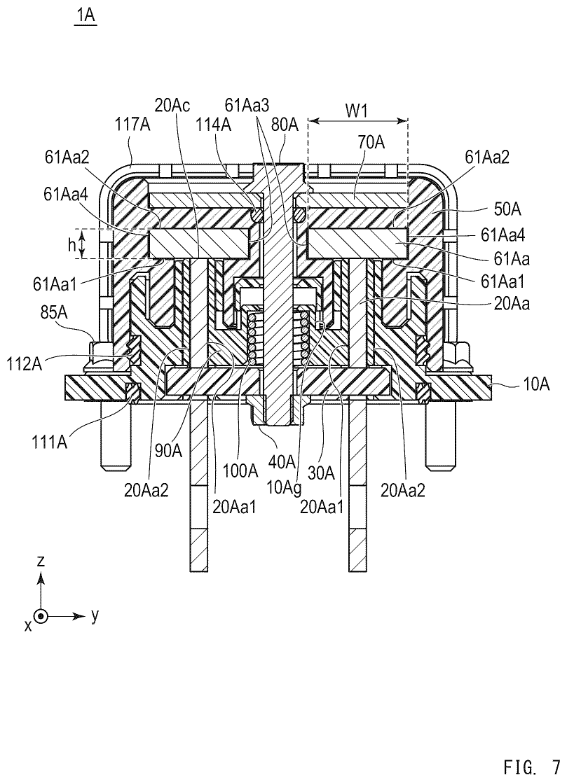

A connection body according to a first embodiment of the present disclosure will be described below with reference to the accompanying drawings. Here, components having the mutually-same functions will be provided with the mutually-same reference characters and the duplicate description thereof will be omitted. FIG. 3 illustrates an example of the connection body according to the first embodiment, where FIG. 3(a) is a perspective view, FIG. 3(b) is a plan view, and FIG. 3(c) is a left side view. FIG. 4 is an exploded perspective view of a connection body 1A. FIG. 5 is a sectional view taken along a K-K line in FIG. 3(b). FIG. 6 is a sectional view taken along an L-L line in FIG. 3(b). FIG. 7 is a sectional view taken along an I-I line in FIG. 3(c).

A connection body of the present disclosure is, for example, a connector for large currents of several hundred amperes. However, the connection body of the present disclosure does not limit the magnitude of the current, and does not preclude application thereof at larger or smaller currents. The connection body 1A according to the present embodiment is composed of a header 2A and a plug harness 3A which is fitted to the header 2A, as illustrated in FIGS. 3 and 4.

### <Header 2A>

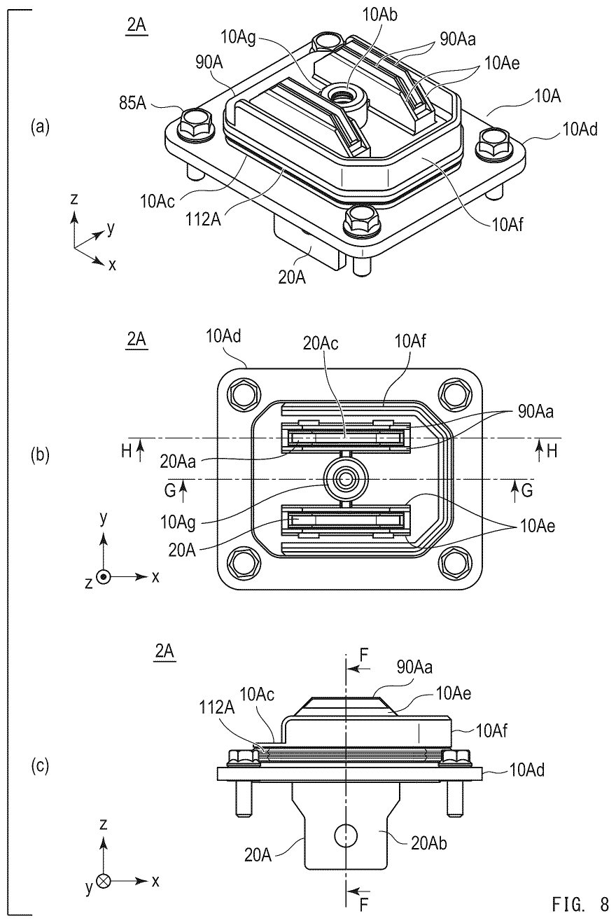

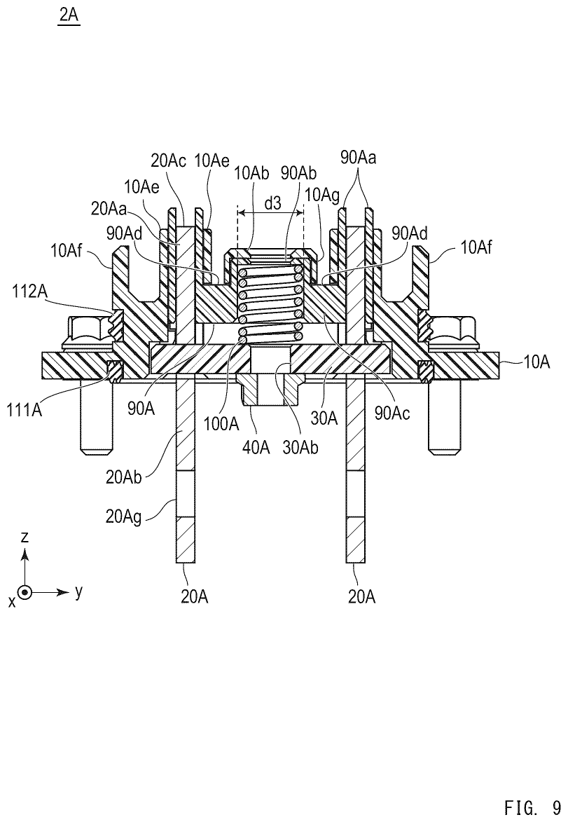

FIG. 8 illustrates the header 2A, where FIG. 8(a) is a perspective view, FIG. 8(b) is a plan view, and FIG. 8(c) is a left side view. FIG. 9 is a sectional view taken along an F-F line in FIG. 8(c). As illustrated in FIGS. 4 and 8, the header 2A includes a first housing 10A, a pair of first terminals 20A, a first holding member 30A, a shutter member 90A, an elastic member 100A, a first seal member 111A, a second seal member 112A, and a nut 40A. The header 2A of the present embodiment includes four sets of bolts 85A and collars 113A for joining with other components such as a circuit board (not shown). However, the header 2A does not have to include the bolts 85A or the collars 113A. In the present embodiment, even a header which does not include the nut 40A may also be referred to as the header 2A.

### (Housing 10A)

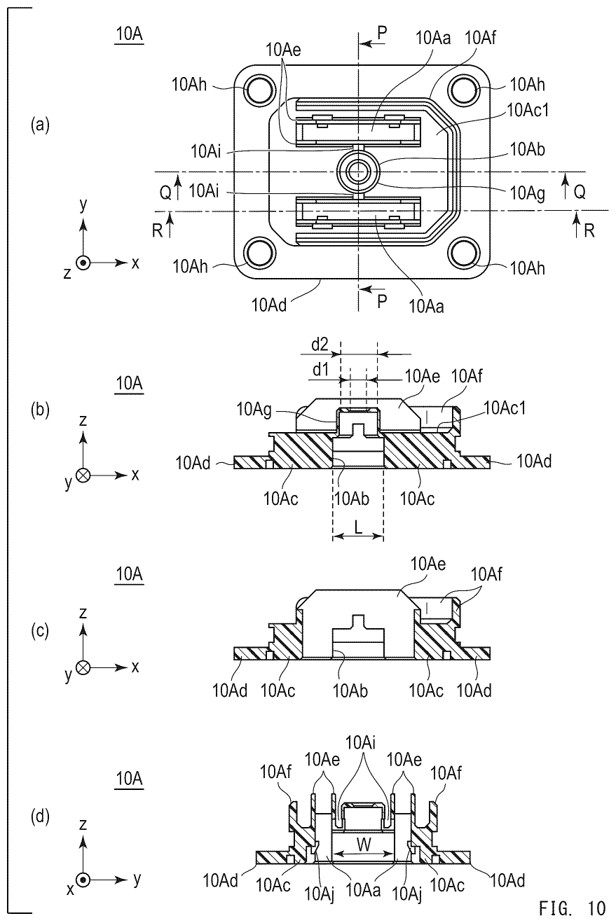

FIG. 10 illustrates the first housing 10A, where FIG. 10(a) is a plan view, FIG. 10(b) is a sectional view taken along a Q-Q line in FIG. 10(a), FIG. 10(c) is a sectional view taken along an R-R line in FIG. 10(a), and FIG. 10(d) is a sectional view taken along a P-P line in FIG. 10(a).

As illustrated in FIG. 9, the first housing 10A accommodates the first terminals 20A, the first holding member 30A, the shutter member 90A, and the elastic member 100A, and positions at least part of each of these components. When the first holding member 30A is inserted in the first housing 10A, the first holding member 30A and the first housing 10A are fitted to each other by a holding mechanism, which is not shown, in the first housing 10A. Accordingly, the pair of first terminals 20A, the shutter member 90A, the elastic member 100A, and the first holding member 30A are held in the first housing 10A. The first housing 10A is made of, for example, an insulating material such as resin. In this example, the first housing 10A has a base 10Ac and a flange portion 10Ad. The base 10Ac is based on a substantially octagonal rectangular cross section, and the flange portion 10Ad extends from the lower end side of the base 10Ac (the end portion side in the −z direction in FIG. 10) in an outward direction in a manner to expand the cross sectional area of the octagonal rectangle so as to form a rounded rectangular outer shape, as illustrated in FIG. 10.

The base 10Ac has a peripheral wall 10Af, which is formed so that peripheral wall 10Af opens a portion of an edge portion on the rear side (the −x direction side in FIG. 10) of an upper surface 10Ac1 and encloses the rest of the edge portion in a raised manner. The base 10Ac has a pair of first hole portions 10Aa and a second bolt insertion portion 10Ab. The first hole portions 10Aa have rectangular hole shapes which are formed in parallel with each other in a penetrating manner in a vertical direction (the z-axis direction in FIG. 10) in a region surrounded by the peripheral wall 10Af. The second bolt insertion portion 10Ab is formed between the pair of first hole portions 10Aa in parallel with the pair of first hole portions 10Aa so as to allow a bolt 80A to be inserted therethrough. The upper surface 10Ac1 has a shutter cover 10Ae around the edge portion of each of the first hole portions 10Aa. The shutter cover 10Ae is formed to be raised upward (the +z direction in FIG. 10) from the first hole portion 10Aa. The shutter cover 10Ae has a shape covering the periphery on the tip end side of a first contact portion 20Aa (FIG. 9). On the upper surface 10Ac1, a boss 10Ag is formed around the end portion of the second bolt insertion portion 10Ab to be extended upward (the +z direction of FIG. 10) from the second bolt insertion portion 10Ab. The size of the hole in the second bolt insertion portion 10Ab, including the size of the hole in the boss 10Ag, has a diameter d1 which is slightly larger than the diameter of the bolt 80A at the entrance of the hole of the boss 10Ag. The second bolt insertion portion 10Ab has a diameter d2 which is slightly larger than the diameter of the elastic member 100A in the direction entering inside (the −z direction in FIG. 10), and further inside, the second bolt insertion portion 10Ab has a rectangular cross-sectional hole shape with width W (FIG. 10(d)) and length L (FIG. 10(b)) which is connected to the first hole portion 10Aa. The upper surface 10Ac1 has a pair of hole portions 10Ai which are formed between each shutter cover 10Ae and the boss 10Ag so that a rib 90Ad of the shutter member 90A can be inserted therethrough.

As illustrated in FIG. 10(a), the flange portion 10Ad has hole portions 10Ah which are formed near four rounded corners and into which the respective collars 113A (FIG. 4) can be inserted by caulking. The collar 113A is made of, for example, metal such as stainless steel, and the bolt 85A can be inserted into each of the hole portions 10Ah to which the collars 113A are attached (FIG. 8).

### (First Terminal 20A)

The first terminal 20A is a conductive flat plate which has the first contact portion 20Aa and an extended portion 20Ab, which is connected to the first contact portion 20Aa, as illustrated in FIGS. 4 and 6. The first terminal 20A is made of copper, in this example.

The first contact portion 20Aa is a flat plate having an octagonal shape obtained by removing the corners of a substantially square shape, and has a first contact surface 20Ac at the end portion on the upper side (the second contact portion 61Aa side, the +z direction side in FIG. 6), as illustrated in FIG. 6. The first contact portions 20Aa have flat plate shapes to be able to be inserted into the respective first hole portions 10Aa (FIG. 10) from the first contact surface 20Ac side. The first contact portion 20Aa is formed to be extended along the z-axis direction in FIG. 4 (that is, the insertion direction of a first bolt insertion portion 30Ab, the second bolt insertion portion 10Ab, and a fifth bolt insertion portion 90Ab).

Each of the first contact portions 20Aa has a hole portion 20Ae which has a substantially horizontally elongated rectangular shape and is positioned slightly downward from the center thereof (on the extended portion 20Ab side, the −z direction side in FIG. 6) and into which a first pressing portion 30Aa of the first holding member 30A is inserted. When the first pressing portion 30Aa is inserted into the hole portions 20Ae, the first contact portion 20Aa is in an upright position with respect to the first holding member 30A. Each of the first contact portions 20Aa has a pair of convex portions 20Ad (FIG. 4) separated by a length greater than the width of the hole portion 20Ae, on the slightly upper end side (the second contact portion 61Aa side, the +z direction side in FIG. 6) relative to the center portion of the surface that faces the outside when the connection body 1A is assembled. The convex portion 20Ad has a substantially trapezoidal cross-sectional shape which gradually changes so that the plate thickness of the first terminal 20A in the portion increases toward the lower side (the −z direction in FIG. 4). In this example, the convex portion 20Ad is formed by dowel processing, and a concave portion is formed on a surface opposite to the surface, on which the convex portion 20Ad is formed, at a position opposed to the convex portion 20Ad. The first terminal 20A thus has the convex portions 20Ad, whereby the first terminal 20A engages with convex portions 10Aj (FIG. 10(d)), which are formed in the first hole portions 10Aa of the first housing 10A, so as to be held in the first housing 10A.

The extended portion 20Ab extends from the lower end (the end portion on the −z direction side in FIG. 6) of the first contact portion 20Aa in a downward direction (the direction away from the second contact portion 61Aa, the −z direction in FIG. 6) in a manner to maintain the width of the lower end. The extended portion 20Ab has a hole portion 20Ag which can be used for coupling with other components (not shown) on the slightly upper end side (the first contact portion 20Aa side, the +z direction side in FIG. 6) relative to the center portion thereof, in this example.

### (First Holding Member 30A)

The first holding member 30A is a plate which has a thin rectangular parallelepiped shape and is made of an insulating material. The first holding member 30A is made of glass epoxy resin in this example. However, as long as the insulation property is ensured, the first holding member 30A may be made of a separator structure of glass epoxy resin and stainless steel, for example. As illustrated in FIG. 4, the first holding member 30A has a pair of first pressing portions 30Aa which are regions on both end portion sides in the longitudinal direction (the y-axis direction in FIG. 4), and a connecting portion 30Ac which connects the pair of first pressing portions 30Aa. The connecting portion 30Ac has the first bolt insertion portion 30Ab, through which the bolt 80A can be inserted, on the center portion thereof. The first holding member 30A presses each of the first terminals 20A from the surface (surface 20Ae1 in FIG. 6) side opposite to the first contact surface 20Ac to the first contact surface 20Ac side in a first state in which the first terminals 20A are inserted into the respective first hole portions 10Aa (FIG. 10) from the first contact surface 20Ac.

Here, the first holding member 30A may have other configurations as long as the first holding member 30A can press the first terminals 20A from the surface side opposite to the first contact surface 20Ac to the first contact surface 20Ac side. For example, instead of the configuration inserting the first pressing portions 30Aa in the hole portion 20Ae, a configuration may be employed in which the first pressing portions 30Aa are bonded to an end portion 20Ah on the lower side (the −z direction side in FIG. 6) of the extended portion 20Ab by using a bonding material or the like so that the first holding member 30A can be pressed from the end portion 20Ah to the first contact surface 20Ac side. In this configuration, other components such as the first housing 10A are to be adjusted in shape appropriately.

### (Shutter Member 90A)

The shutter member 90A is an insulating member including a pair of shutter portions 90Aa, a connecting portion 90Ac, which connects the pair of shutter portions 90Aa, and the fifth bolt insertion portion 90Ab, which is formed in a center portion of the connecting portion 90Ac and has a boss shape and through which the bolt 80A can be inserted, as illustrated in FIG. 4. The shutter member 90A is made of resin in this example.

The shutter portion 90Aa has a box-like shape which opens in the vertical direction (the z-axis direction in FIG. 4) to allow insertion and movement of the first terminal 20A. The shutter portion 90Aa has a shape covering the periphery on the tip end side of the first contact portion 20Aa. In other words, the pair of shutter portions 90Aa cover respective peripheries of one end portions of the pair of first contact portions 20Aa with the end portions thereof exposed.

The shutter member 90A has a pair of ribs 90Ad on the connecting portion 90Ac so as to further strongly support the shutter portions 90Aa and the fifth bolt insertion portion 90Ab, as illustrated in FIG. 9.

As the shape of the hole inside the fifth bolt insertion portion 90Ab, the entrance has a diameter slightly larger than the bolt 80A, and the inside is formed in a shape of a hole with a diameter d3 which is slightly larger than the elastic member 100A so that the elastic member 100A can be inserted.

### (Elastic Member 100A)

The elastic member 100A of the present embodiment has a coil spring shape as illustrated in FIG. 9. The elastic member 100A is made of stainless steel in this example. The elastic member 100A has an inner diameter which is slightly larger than the diameter of the bolt 80A so that the bolt 80A can be inserted therethrough. One end of the elastic member 100A is inserted into the first bolt insertion portion 30Ab of the first holding member 30A and thus, the elastic member 100A and the first holding member 30A are fitted to each other. The other end is inserted into the inside of the fifth bolt insertion portion 90Ab. Accordingly, at least a portion of the elastic member 100A is positioned between the first holding member 30A and the connecting portion 90Ac when the header 2A is assembled.

The provision of the elastic member 100A produces the following positional relationship between the shutter portion 90Aa and the first contact portion 20Aa in the header 2A before the header 2A and the plug harness 3A are fitted to each other. As illustrated in FIG. 8, the end portion on the upper side (the +z direction side in FIG. 8) of the first contact portion 20Aa is positioned in the inside of the opening portion formed by the shutter portion 90Aa. That is, the tip end of the shutter portion 90Aa is positioned on the upper side (the +z direction side in FIG. 8) compared to the tip end of the first contact surface 20Ac. This configuration ensures safety by preventing a human finger or the like from directly touching the first terminal 20A from the shutter portion 90Aa side. Even if a person were to press down the shutter portion 90Aa, the elastic member 100A is compressed to exert a spring reaction force, making it difficult to press down the shutter portion 90Aa more than a predetermined amount with the force of a finger press down. Meanwhile, by fastening the header 2A and the plug harness 3A using the bolt 80A, the first terminal 20A moves upward (in the +z direction in FIG. 7) with respect to the shutter member 90A to a position where the first contact surface 20Ac is flush with the tip end of the shutter portion 90Aa. In other words, the elastic member 100A causes the shutter member 90A to move from a position where the end portion (the first contact surface 20Ac) of the first contact portion 20Aa is within the opening portion formed by the shutter member 90A (FIGS. 8 and 9) to a position where the end portion of the first contact portion 20Aa and the end portion of the tip of the shutter member 90A are flush with each other (FIG. 7) from before the completion of fastening of the header 2A with the plug harness 3A by the bolt 80A to the completion. To put it further, before fastening is completed, the shutter member 90A is pressed by the elastic member 100A, and the end portion of the shutter portion 90Aa is accordingly positioned on the pressing direction side of the first pressing portion 30Aa (the +z direction side in FIG. 8) relative to the end portion (the first contact surface 20Ac) of the first contact portion 20Aa. From before the completion of fastening to the completion, the shutter member 90A moves to a position where the end portion (the first contact surface 20Ac) of the first contact portion 20Aa is allowed to be conduct with the second contact portion 61Aa (the −z direction side in FIG. 8). Accordingly, the first contact surface 20Ac is joined with the second contact portion 61Aa. The shutter member 90A has a concave portion 90Ae, which allows the shutter member 90A to move downward (the −z direction side in FIG. 8) with respect to the first terminal 20A without interfering with the convex portion 10Aj.

### <Plug Harness 3A>

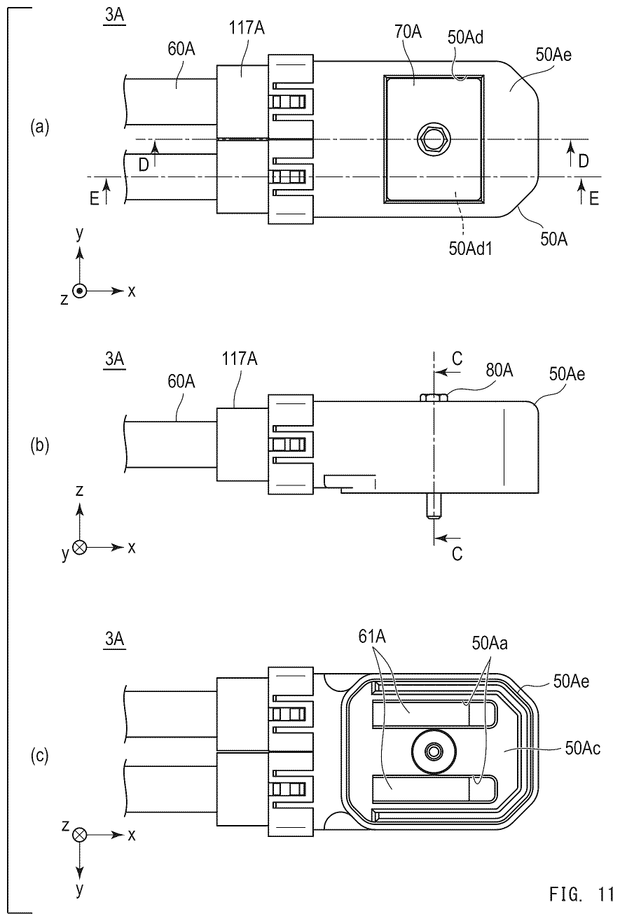

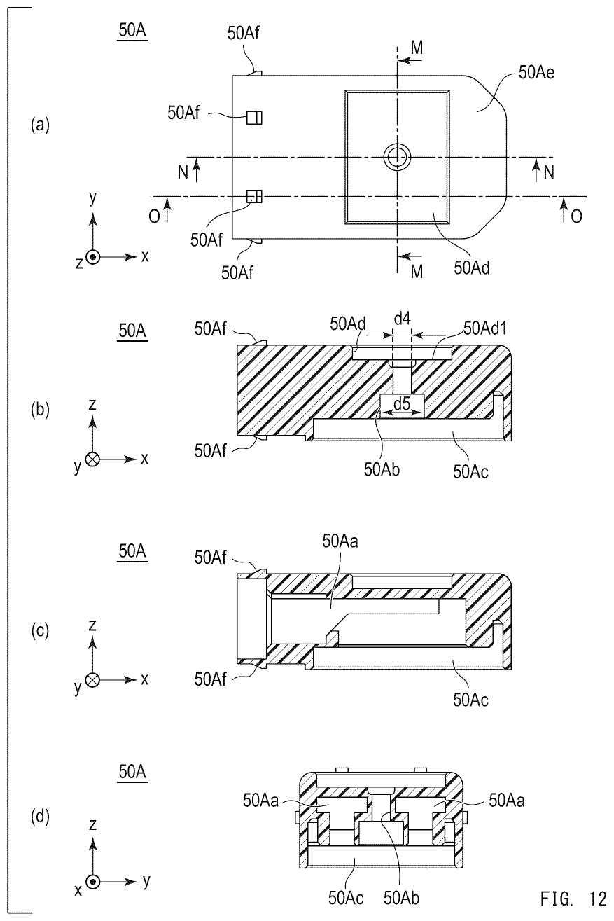

FIG. 11 illustrates the plug harness 3A, where FIG. 11(a) is a plan view, FIG. 11(b) is a left side view, and FIG. 11(c) is a bottom surface view. FIG. 12 illustrates a second housing 50A, where FIG. 12(a) is a plan view, FIG. 12(b) is a sectional view taken along an N-N line in FIG. 12(a), FIG. 12(c) is a sectional view taken along an O-O line in FIG. 12(a), and FIG. 12(d) is a sectional view taken along an M-M line in FIG. 12(a).

As illustrated in FIGS. 4 and 11, the plug harness 3A includes the second housing 50A, a harness 60A, a second holding member 70A, a seal member 114A, and the bolt 80A. The plug harness 3A of the present embodiment includes seal members 115A, cable retainers 116A, and covers 117A around the harness 60A, as illustrated in FIG. 4. In the present embodiment, even a plug harness which does not include the bolt 80A, the seal members 115A, the cable retainers 116A, or the covers 117A may also be referred to as the plug harness 3A.

### (Second Housing 50A)

The second housing 50A has a substantially rectangular parallelepiped shape with one end tapered as illustrated in FIG. 12, and is made of, for example, an insulating material such as resin. The second housing 50A positions second terminals 61A and the second holding member 70A.

The second housing 50A has a pair of second hole portions 50Aa, an opening portion 50Ac, and a third bolt insertion portion 50Ab through which the bolt 80A can be inserted.

The pair of second hole portions 50Aa in this example are formed parallel to (in parallel with) the longitudinal direction (the x-axis direction in FIG. 12) of the second housing 50A so that the rear side (the −x direction side in FIG. 12) is open and the front side (the +x direction side in FIG. 12) is closed. The second hole portions 50Aa are formed in parallel so that at least portions thereof face the first contact surfaces 20Ac when the plug harness 3A is fitted to the header 2A. The second hole portion 50Aa has a hole shape whose tip end side is slightly larger than the shape of the second terminal 61A so that the second terminal 61A side of the harness 60A can be inserted therein, as illustrated in FIG. 12(c). The center portion of the hole in the extension direction has a hole shape slightly larger than the outer shape of a cable 62A. The end portion near the entrance of the hole (the end portion on the −x direction side in FIG. 12) is formed into a rectangular hole shape so that the seal member 115A (FIG. 4) serving as a waterproof member can be inserted.

The opening portion 50Ac is formed so as to encompass a portion of each of the second hole portions 50Aa and open in one direction (the −z direction in FIG. 12) of a first axis (an axis parallel to the z axis in FIG. 12) that intersects with the hole direction of the second hole portion 50Aa. Accordingly, the cross-sectional shape of the opening portion 50Ac is such that an O-O cross section of FIG. 12(a), which encompasses a portion of the second hole portion 50Aa, has the shape illustrated in FIG. 12(c), while in a portion without the second hole portion 50Aa, for example, an N-N cross section of FIG. 12(a) has the shape illustrated in FIG. 12(b). Thus, the opening portion 50Ac is formed so that the base 10Ac, peripheral wall 10Af, shutter covers 10Ae, and boss 10Ag of the first housing 10A are accommodated within the second housing 50A, as shown in FIGS. 5 to 7. That is, the second housing 50A is formed to be able to be fitted to the first housing 10A.

The third bolt insertion portion 50Ab is formed between the pair of second hole portions 50Aa in parallel with the above-mentioned first axis (the z axis in FIG. 12) so as to penetrate through the second housing 50A, as illustrated in FIG. 12. The third bolt insertion portion 50Ab is formed on a position facing the second bolt insertion portion 10Ab when the second housing 50A is fitted to the first housing 10A. The size of the hole of the third bolt insertion portion 50Ab has a diameter d4 which is slightly larger than that of the bolt 80A near a surface 50Ad1 described below. In the direction entering the inside, the third bolt insertion portion 50Ab has a diameter d5 slightly larger than the boss 10Ag, and further inward, the third bolt insertion portion 50Ab expands into a hole that can accommodate the base 10Ac.

The second housing 50A has the surface 50Ad1 in a region from near the center to the front side (the +x direction side in FIG. 12) in an upper surface 50Ae thereof. The surface 50Ad1 in this example is formed as a surface of a groove portion 50Ad which is slightly lower than the upper surface 50Ae. The surface 50Ad1 forms a predetermined region on which the second holding member 70A is to be mounted. The groove portion 50Ad is not an essential structure in the present disclosure, and it is sufficient that the upper surface 50Ae has the region on which the second holding member 70A is mounted (a region corresponding to the surface 50Ad1). Therefore, the upper surface 50Ae including the surface 50Ad1 may be simply referred to as the “upper surface 50Ae” or “first surface”. Here, around the end portion on the rear side of the second housing 50A, a plurality of convex portions 50Af for fitting the cover 117A to the second housing 50A are formed.

### (Harness 60A)

The harness 60A is composed of the cables 62A and the second terminals 61A, as illustrated in FIGS. 4 and 11. The cable 62A is composed of a copper wire 62Aa made of copper alloys, and an insulating material 62Ab covering the copper wire 62Aa. The copper wire 62Aa is exposed in one end of the cable 62A, and the copper wire 62Aa in the exposed portion forms the second terminal 61A which has a gradual change portion, whose cross section gradually changes from a circular shape to a rectangular shape, and a thin substantially-rectangular-parallelepiped portion extending from the gradual change portion to the tip end, in this example. The second terminal 61A forms a thin copper plate. In the present embodiment, the above-mentioned gradual change portion and substantially-rectangular-parallelepiped portion are together referred to as the second terminal 61A. In particular, a substantially-rectangular-parallelepiped portion is also referred to as the second contact portion 61Aa. The second contact portion 61Aa is solidified by compaction processing in this example. That is, each of the pair of second terminals 61A is composed of a plurality of core wires (copper wires), and each of the second contact portions 61Aa is solidified by performing compaction processing to the core wires to form a substantially rectangular parallelepiped shape. The compaction processing facilitates miniaturization of the plug harness 3A. The second contact portion 61Aa has a surface 61Aa1 and a surface 61Aa2 opposite to the surface 61Aa1, which constitute a thickness h which is the plate thickness, as illustrated in FIG. 7. The second contact portion 61Aa has a flat plate shape which can be inserted into the second hole portion 50Aa in this example.

### (Second Holding Member 70A)

The second holding member 70A is a metal plate made of a thin rectangular flat plate with four rounded corners, as illustrated in FIG. 4. The second holding member 70A is made of stainless steel in this example. The second holding member 70A has a second pressing portion 70Aa and a fourth bolt insertion portion 70Ab. The second pressing portion 70Aa has a thin rectangular shape and is used for pressing a predetermined region (the surface 50Ad1) of the upper surface 50Ae, which is an outer surface of the second housing 50A and in which the third bolt insertion portion 50Ab is formed, in one direction (the −z direction in FIG. 4). The fourth bolt insertion portion 70Ab is formed on the center portion of the second pressing portion 70Aa so that the bolt 80A can be inserted therethrough. The fourth bolt insertion portion 70Ab is formed on a position facing the third bolt insertion portion 50Ab when the second holding member 70A is mounted on the surface 50Ad1. The second holding member 70A and the predetermined region (the surface 50Ad1) come into contact by a surface-to-surface contact. Therefore, even if the second housing 50A is made of resin, for example, depression (denting) of the contact part is prevented.

The connection body 1A includes the seal member 114A which forms an O ring as a waterproof member in this example. For example, when busbars are screwed together, an over-housing for waterproofing is separately required for waterproof structure. In the connection body 1A, the seal member 114A serving as a waterproof member is attached to the third bolt insertion portion 50Ab from the upper surface 50Ae side, and then the second pressing portion 70Aa of the second holding member 70A is mounted on the surface 50Ad1. That is, the seal member 114A is provided on the second holding member 70A side on the third bolt insertion portion 50Ab. Accordingly, the connection body 1A does not require an over-housing.

### <Method for Connecting Connection Body 1A>

The method for connecting the connection body 1A can be performed, for example, by assembling the connection body 1A in accordance with processes (1) to (8) below. However, the processes in the method for connecting the connection body 1A are not limited to the processes described below. Further, in the description below, the process of attaching the bolts 85A and the collars 113A is omitted.

(1) For waterproofing, the first seal member 111A, which is an annular-shaped waterproof member, is attached to the groove portion, which is formed near the joint between the flange portion 10Ad and the base 10Ac, from the bottom surface side of the first housing 10A, as illustrated in FIG. 9. The second seal member 112A, which is an annular-shaped waterproof member, is attached to the groove portion, which is formed around the base 10Ac, from the boss 10Ag side of the first housing 10A.

(2) The first pressing portions 30Aa of the first holding member 30A are inserted into the respective hole portions 20Ae of the first terminals 20A in a state in which one end of the elastic member 100A faces the first bolt insertion portion 30Ab of the first holding member 30A.

(3) The first contact portions 20Aa of the first terminals 20A are inserted into the respective shutter portions 90Aa and the other end of the elastic member 100A is inserted into the fifth bolt insertion portion 90Ab of the shutter member 90A.

(4) In the state of (3), the shutter portions 90Aa are inserted into the respective first hole portions 10Aa, and the fifth bolt insertion portion 90Ab is inserted into the boss 10Ag. In terms of the insertion depth, the insertion is continued until the convex portions 10Aj and the respective convex portions 20Ad are engaged with each other. Through the engagement between the convex portions 10Aj and the convex portions 20Ad, the pair of first terminals 20A, the shutter member 90A, the elastic member 100A, and the first holding member 30A are held in the first housing 10A. At this time, the ribs 90Ad are inserted through the hole portions 10Ai, whereby the shutter member 90A is movable upward with respect to the first housing 10A. The reaction force of the elastic member 100A produces the state in which the pair of shutter portions 90Aa cover the peripheries of respective one end portions of the pair of first contact portions 20Aa with the end portions exposed, as illustrated in FIG. 9.

(5) The pair of second terminals 61A are inserted into the respective second hole portions 50Aa in a state in which the seal members 115A, the cable retainers 116A, and the covers 117A are attached to the second terminals 61A (see FIG. 6). Then, the seal members 115A, the cable retainers 116A, and the covers 117A are fitted to the first housing 10A in this order.

(6) The first housing 10A and the second housing 50A are fitted to each other in a manner in which each of the first hole portions 10Aa and the opening portion 50Ac face each other (FIGS. 4 and 6).

(7) The seal member 114A, which forms an O ring as a waterproof member in this example, is attached to the third bolt insertion portion 50Ab from the upper surface 50Ae side, and the second pressing portion 70Aa of the second holding member 70A is mounted on the surface 50Ad1.

(8) The bolt 80A is inserted through the fourth bolt insertion portion 70Ab, the third bolt insertion portion 50Ab, the second bolt insertion portion 10Ab, the fifth bolt insertion portion 90Ab, the elastic member 100A, and the first bolt insertion portion 30Ab in this order, and the nut 40A is attached to the bolt 80A from the lower side of the first holding member 30A, thereby fastening the header 2A and the plug harness 3A. This fastening moves the end portions of the first contact portions 20Aa from the position where the end portions are within the opening portion formed by the shutter member 90A (FIGS. 8 and 9) to the position where the end portions are flush with the end portion of the tip of the shutter member 90A (FIG. 7). In other words, the elastic member 100A causes the shutter member 90A to move from a position where the end portion (the first contact surface 20Ac) of the first contact portion 20Aa is within the opening portion formed by the shutter member 90A (FIGS. 8 and 9) to a position where the end portion of the first contact portion 20Aa and the end portion of the tip of the shutter member 90A are flush with each other (FIG. 7) from before the completion of fastening of the header 2A with the plug harness 3A by the bolt 80A to the completion. To put it further, before fastening is completed, the shutter member 90A is pressed by the elastic member 100A, and the end portion of the shutter portion 90Aa is accordingly positioned on the pressing direction side of the first pressing portion 30Aa (the +z direction side in FIG. 8) relative to the end portion (the first contact surface 20Ac) of the first contact portion 20Aa. From before the completion of fastening to the completion, the shutter member 90A moves to a position where the end portion (the first contact surface 20Ac) of the first contact portion 20Aa is allowed to be conduct with the second contact portion 61Aa (the −z direction side in FIG. 8). Accordingly, the first contact surface 20Ac is joined with the second contact portion 61Aa.

The connection body 1A is configured so that the first bolt insertion portion 30Ab faces the fifth bolt insertion portion 90Ab, the fifth bolt insertion portion 90Ab faces the second bolt insertion portion 10Ab, the second bolt insertion portion 10Ab faces the third bolt insertion portion 50Ab, and the third bolt insertion portion 50Ab faces the fourth bolt insertion portion 70Ab. Namely, the relative positional relationship between the fourth bolt insertion portion 70Ab, the third bolt insertion portion 50Ab, the second bolt insertion portion 10Ab, the fifth bolt insertion portion 90Ab, and the first bolt insertion portion 30Ab is a positional relationship which allows fastening by insertion of the bolt 80A. In the connection body 1A of the present disclosure, the fastening by the bolt 80A makes the first contact portions 20Aa and the respective second contact portions 61Aa conductive.

The relative positional relationship focusing on the first bolt insertion portion 30Ab, the second bolt insertion portion 10Ab, the third bolt insertion portion 50Ab, and the fourth bolt insertion portion 70Ab is, in other words, as follows. That is, the first terminals 20A are inserted into the respective first hole portions 10Aa from the first contact surface 20Ac (this state is also referred to as the “first state”). In the first state, the pair of first pressing portions 30Aa are allowed to press the respective first terminals 20A, the pair of second terminals 61A are inserted into the respective second hole portions 50Aa provided in pair, the first housing 10A and the second housing 50A are fitted to each other in a manner in which each of the first hole portions 10Aa and the opening portion 50Ac face each other, the second pressing portion 70Aa of the second holding member 70A is mounted on the predetermined region (the surface 50Ad1), and the first pressing portions 30Aa of the first holding member 30A are allowed to be abutted on the respective surfaces opposite to the first contact surfaces 20Ac of the first terminals 20A (this state is also referred to as the “second state”). The relative positional relationship between the first bolt insertion portion 30Ab, the second bolt insertion portion 10Ab, the third bolt insertion portion 50Ab, and the fourth bolt insertion portion 70Ab is the positional relationship that allows fastening by insertion of a single bolt (the bolt 80), in this second state. This fastening by the bolt 80A makes the first contact portions 20Aa and the respective second contact portions 61Aa conductive.

The connection body 1A of the present embodiment is configured so that the header 2A and the plug harness 3A are fitted to each other and fastening by the fitting can be performed with one bolt 80A. The connection body 1A is configured to directly join the first terminals 20A to the second terminals 61A. The direct joining can be performed by a single bolt 80A (and the nut 40A). Accordingly, this configuration does not require, for example, a separate metal fitting such as the second terminal metal fitting body 86 of Patent Literature 1, which is joined to terminals to join terminals. Further, the connection body 1A is configured so that the first terminals 20A and the second terminals 61A are directly joined to each other to be conductive. Patent Literature 1 employs the configuration joining by the clip spring 88 serving as an elastic member. The joining by springs requires plating to reduce contact resistance. The connection body 1A can achieve conduction between terminals by direct joining between the first terminals 20A and the second terminals 61A. Further, the connection body 1A can obtain high contact force by bolt fastening force and can accordingly significantly reduce the electrical resistance, eliminating necessity of plating. As a result, the connection body 1A of the present disclosure can suppress increase in the number of components and can achieve connection that can withstand large currents.

In the present embodiment, the harness 60A is mounted so that the surfaces 61Aa1 are abutted on the end portions (the first contact surfaces 20Ac) on the upper side (the +z direction side in FIG. 7) of the first contact portions 20Aa. The present embodiment is not limited to this configuration.

For example, the harness 60A may be configured so that the harness 60A is rotated by 90 degrees around the longitudinal direction (the x-axis direction in FIG. 7) of the harness 60A as an axis, and surfaces 61Aa3 or surfaces 61Aa4 (see FIG. 7) are abutted on the end portions (the first contact surfaces 20Ac) on the upper side of the first contact portions 20Aa.

Alternatively, the first terminals 20A may be configured so that the first terminals 20A are rotated by 90 degrees around the longitudinal direction (the x-axis direction in FIG. 4) of the harness 60A as an axis and the surfaces 61Aa1 (see FIG. 7) are abutted on surfaces 20Aa1 (or surfaces 20Aa2), forming a flat plate shape, of the first contact portions 20Aa. In these configurations, the shapes of other components, including the first housing 10A, the second housing 50A, and the like, are to be changed as appropriate in accordance with the arrangement positions of the shapes.

Thus, in the connection body 1A of the present embodiment, the pair of first contact portions 20Aa and the pair of second contact portions 61Aa may be provided so that at least one of the pair of first contact portions 20Aa and the pair of second contact portions 61Aa are raised “along” the insertion direction of the bolt 80A or may be provided so that at least one of the pair of first contact portions 20Aa and the pair of second contact portions 61Aa are raised “with respect to” the insertion direction of the bolt 80A, as long as the first contact portions 20Aa and the second contact portions 61Aa can be directly joined to each other.

### Second Embodiment

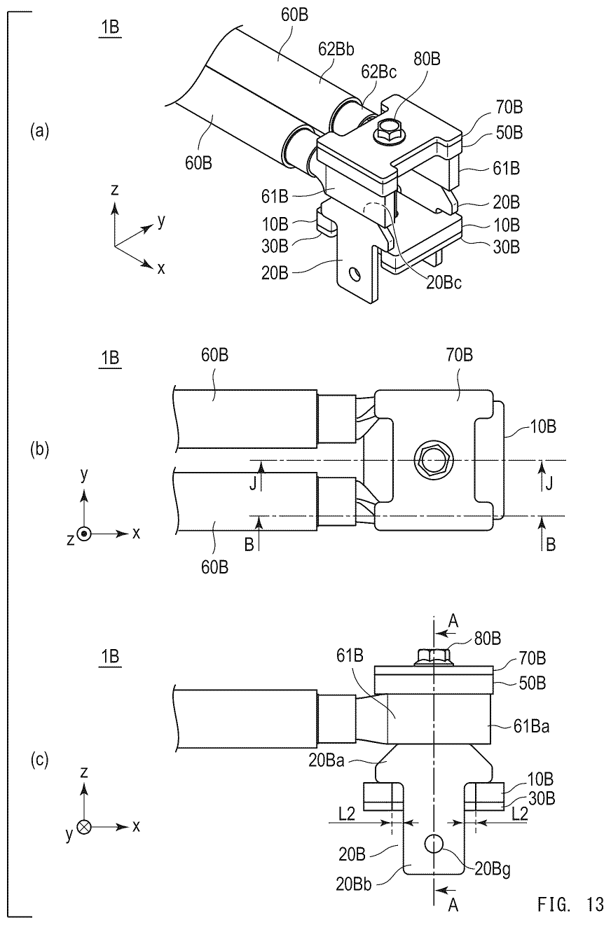

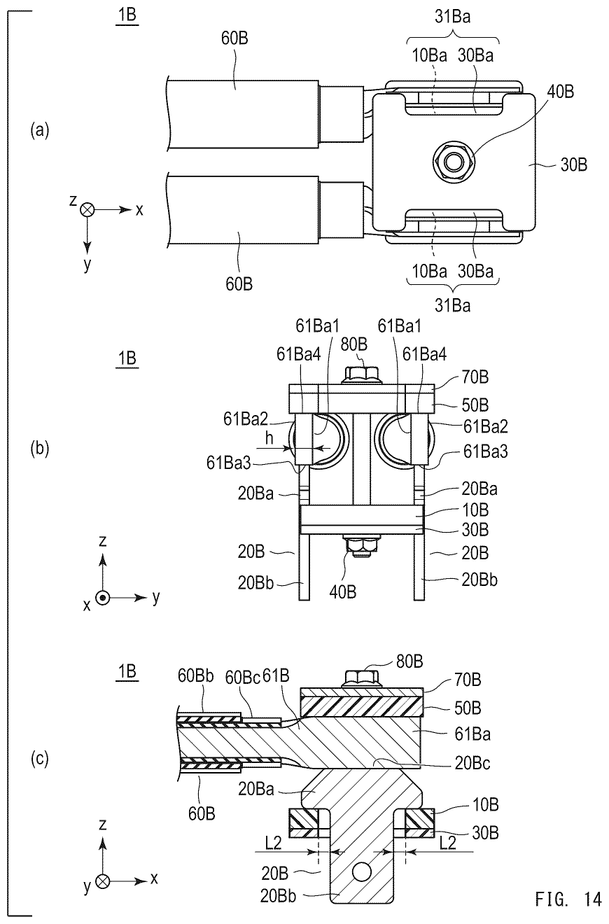

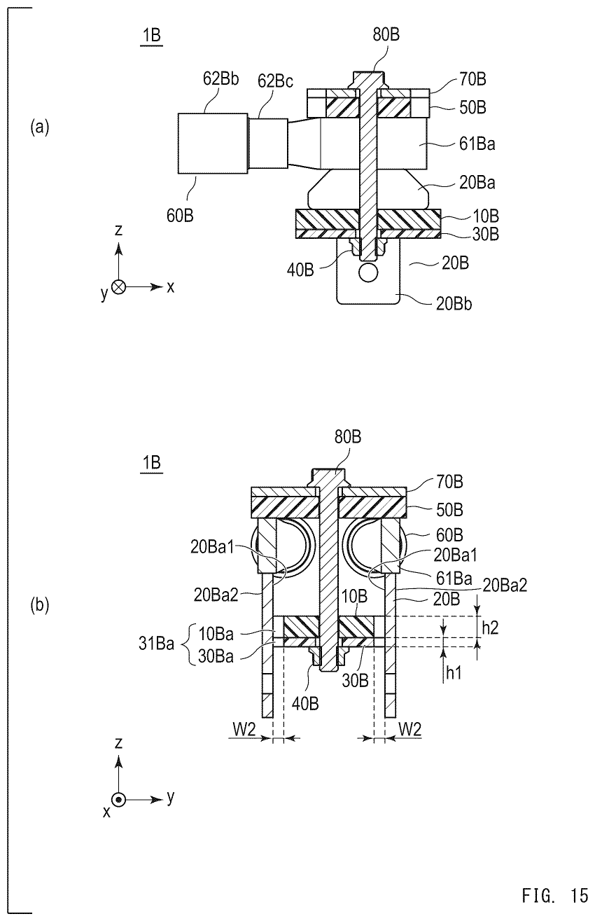

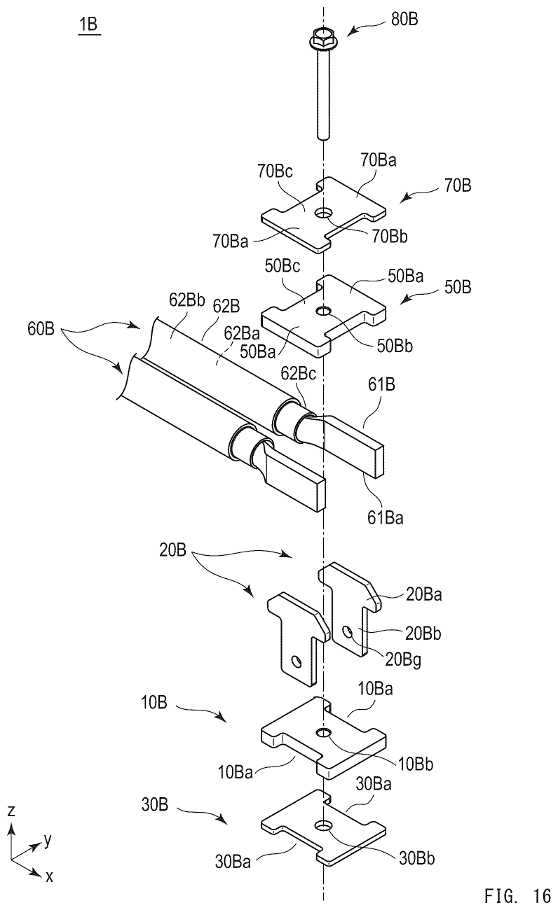

A connection body according to a second embodiment of the present disclosure will be described below with reference to the accompanying drawings. FIG. 13 illustrates an example of the connection body according to the second embodiment, where FIG. 13(a) is a perspective view, FIG. 13(b) is a plan view, and FIG. 13(c) is a left side view. FIG. 14 illustrates a connection body 1B, where FIG. 14(a) is a bottom surface view, FIG. 14(b) is an elevational view, and FIG. 14(c) is a sectional view taken along a B-B line in FIG. 13(b). FIG. 15 illustrates the connection body 1B, where FIG. 15(a) is a sectional view taken along a J-J line in FIG. 13(b), and FIG. 15(b) is a sectional view taken along an A-A line in FIG. 13(c). FIG. 16 is an exploded perspective view of the connection body 1B.

The first embodiment employs the configuration in which the first housing 10A positions the first terminals 20A, the second housing 50A positions the second terminals 61A, and the first terminals 20A and the second terminals 61A are directly joined. The connection body of the present disclosure may be the connection body 1B according to the second embodiment described below, which does not use the first housing 10A or the second housing 50A.

The connection body 1B according to the present embodiment includes a first metal plate 30B, a first insulating plate 10B, a pair of first terminals 20B, a pair of harnesses 60B, a second insulating plate 50B, a second metal plate 70B, a bolt 80B, and a nut 40B, as illustrated in FIGS. 13, 14, and 16. Here, FIG. 16 does not show the nut 40B.

### (First Metal Plate 30B)

The first metal plate 30B is a metal plate based on a thin substantially-rectangular flat plate, as illustrated in FIG. 16. The first metal plate 30B is made of stainless steel in this example. The first metal plate 30B has a pair of first cutout portions 30Ba near the center of both end portions in the short side direction (the y-axis direction in FIG. 16). The first metal plate 30B has a first bolt insertion portion 30Bb, through which the bolt 80B can be inserted, between the pair of first cutout portions 30Ba. The first metal plate 30B presses the first terminals 20B with the first insulating plate 10B interposed therebetween.

### (First Insulating Plate 10B)

The first insulating plate 10B is an insulating plate based on a thin rectangular flat plate, as illustrated in FIG. 16. The first insulating plate 10B is made of glass epoxy resin in this example. The first insulating plate 10B has a pair of second cutout portions 10Ba near the center of both end portions in the short side direction (the y-axis direction in FIG. 16). The second cutout portions 10Ba are formed on positions facing the pair of first cutout portions 30Ba when the first insulating plate 10B is mounted on the first metal plate 30B. The first insulating plate 10B has a second bolt insertion portion 10Bb, through which the bolt 80B can be inserted, between the pair of second cutout portions 10Ba. The second bolt insertion portion 10Bb is formed on a position facing the first bolt insertion portion 30Bb when the first insulating plate 10B is mounted on the first metal plate 30B.

The first insulating plate 10B is provided between each of first contact portions 20Ba of the first terminals 20B and the first metal plate 30B so as to insulate each of the first contact portions 20Ba from the first metal plate 30B and press the first terminals 20B by the pressing force from the first metal plate 30B. The first insulating plate 10B has the thickness h2, which is at least twice the thickness h1 of the first metal plate 30B in this example (FIG. 15(b)), but other external shapes thereof are the same as those of the first metal plate 30B. The present embodiment calls a state, in which the first insulating plate 10B is mounted on the first metal plate 30B with the pair of first cutout portions 30Ba and the pair of second cutout portions 10Ba facing each other, as a first state. A cutout portion formed by the first cutout portion 30Ba and the second cutout portion 10Ba in this first state is to be referred to as a third cutout portion 31Ba (FIG. 14(a) and FIG. 15(b)). The connection body 1B has a pair of third cutout portions 31Ba in this example.

### (First Terminal 20B)

Each of the first terminals 20B is a conductive flat plate which has a base portion 20Bb and the first contact portion 20Ba, as illustrated in FIG. 16. The first terminal 20B is made of copper, in this example.

The base portion 20Bb has a flat plate shape which can be inserted into the third cutout portion 31Ba, which is formed by the first cutout portion 30Ba and the second cutout portion 10Ba, in the above-mentioned first state. The base portion 20Bb forms a rectangular flat plate in this example. The base portion 20Bb has a hole portion 20Bg, which can be used for coupling with other components, on the slightly lower end side (the −z direction side in FIG. 13) from the center portion thereof, in this example.

The first contact portion 20Ba is connected with one end of the base portion 20Bb in the longitudinal direction (the z-axis direction in FIG. 13), and has a flat plate shape which has a width, which is greater than that of the third cutout portion 31Ba, on both sides in the width direction of the base portion 20Bb (the x-axis direction in FIG. 13) and is extended in a manner to be tapered upward (the +z direction side in FIG. 13).

The first terminals 20B and the first metal plate 30B are provided so as to have a predetermined interval therebetween without coming into contact with each other when the connection body 1B is assembled. In this example, there are gaps L2 in the longitudinal direction (the x-axis direction in FIG. 13(c)) of the connection body 1B and there are gaps W2 in the width direction (the y-axis direction in FIG. 15(b)) of the connection body 1B. The first insulating plate 10B having the thickness h2 is provided between the first metal plates 30B and the first contact portion 20Ba to prevent a short circuit in the z-axis direction. The gaps L2 and W2 are formed between the first terminals 20B and the first metal plate 30B to prevent a short circuit in the x-axis direction and the y-axis direction.

### (Harness 60B)

The harness 60B is composed of a cable 62B and a second terminal 61B, as illustrated in FIG. 16. The cable 62B is composed of a copper wire 62Ba made of copper alloys, and insulating materials 62Bb and 62Bc covering the copper wire 62Ba. The copper wire 62Ba is exposed in one end of the cable 62B, and the copper wire 62Ba in the exposed portion forms the second terminal 61B which has a gradual change portion, whose cross section gradually changes from a circular shape to a rectangular shape, and a thin substantially-rectangular-parallelepiped portion extending from the gradual change portion to the tip end, in this example. The second terminal 61B forms a thin copper plate. In the present embodiment, the above-mentioned gradual change portion and substantially-rectangular-parallelepiped portion are together referred to as the second terminal 61B. In particular, a substantially-rectangular-parallelepiped portion is also referred to as a second contact portion 61Ba. The second contact portion 61Ba is solidified by compaction processing in this example. That is, each of the pair of second terminals 61B is composed of a plurality of core wires (copper wires), and each of the second contact portions 61Ba is solidified by performing compaction processing to the core wires to form a substantially rectangular parallelepiped shape. The second contact portion 61Ba has a surface 61Ba1 and a surface 61Ba2 opposite to the surface 61Ba1, which form the thickness h which is the plate thickness, in the horizontal direction (the y-axis direction in FIG. 14), as illustrated in FIG. 14(b). The second contact portion 61Ba has a surface 61Ba3 and a surface 61Ba4 on both end portions in the short side direction (the z-axis direction). The pair of harnesses 60B in this example are provided in parallel so as to be line-symmetrical with each other. That is, the surfaces 61Ba1 face inward toward each other, and the surfaces 61Ba2 face outward from each other. For convenience of explanation, the surfaces, which face downward in the state in which the connection body 1B is assembled, on the end portions of the second contact portions 61Ba are both referred to as the surfaces 61Ba3, and the surfaces, which face upward in the same state, on the end portions are both referred to as the surfaces 61Ba4 (FIG. 14(b)), in the present embodiment. That is, the pair of second terminals 61B have respective second contact portions 61Ba that have a flat plate shape and can be mounted on the end portions (first contact surfaces 20Bc), which are on an opposite side to the base portions 20Bb, of the first contact portions 20Ba in the pair of first terminals 20B.

### (Second Insulating Plate 50B)

The second insulating plate 50B is an insulating plate based on a thin rectangular flat plate. The second insulating plate 50B is made of glass epoxy resin in this example. As illustrated in FIG. 16, the second insulating plate 50B is composed of a pair of first pressing portions 50Ba and a first coupling portion 50Bc which couples the pair of first pressing portions 50Ba.

The first pressing portions 50Ba are regions which can be mounted on surfaces, which are on an opposite side to the first terminals 20B, of the second contact portions 61Ba in the pair of second terminals 61B.

The first coupling portion 50Bc has a third bolt insertion portion 50Bb, through which the bolt 80B can be inserted, on the center portion thereof. The third bolt insertion portion 50Bb is formed on a position facing the second bolt insertion portion 10Bb in the first state when the connection body 1B is assembled.

### (Second Metal Plate 70B)

The second metal plate 70B is a metal plate based on a thin rectangular flat plate. The second metal plate 70B is made of stainless steel in this example. As illustrated in FIG. 16, the second metal plate 70B is composed of a pair of second pressing portions 70Ba and a second coupling portion 70Bc which couples the pair of second pressing portions 70Ba. The second pressing portions 70Ba are regions which can be mounted on the first pressing portion 50Ba, which is on an opposite side to the second contact portions 61Ba, in the pair of first pressing portions 50Ba. The second coupling portion 70Bc has a fourth bolt insertion portion 70Bb, through which the bolt 80B can be inserted, on the center portion thereof. The fourth bolt insertion portion 70Bb is formed on a position facing the third bolt insertion portion 50Bb when the connection body 1B is assembled.

### <Method for Connecting Connection Body 1B>

The method for connecting the connection body 1B can be performed, for example, by assembling the connection body 1B in accordance with processes (1) to (6) below. However, the processes in the method for connecting the connection body 1B are not limited to the processes described below.

(1) The first insulating plate 10B is mounted on the first metal plate 30B with the pair of first cutout portions 30Ba and the pair of second cutout portions 10Ba facing each other (defined as the above-mentioned first state).

(2) The base portions 20Bb of the first terminals 20B are inserted into the respective third cutout portions 31Ba in the first state. This insertion is performed so that the first contact portions 20Ba are on the upper side (the +z direction side in FIG. 16) and the base portions 20Bb are on the lower side (the −z direction side in FIG. 16). At this time, the first terminals 20B and the first metal plate 30B are adjusted so as to have a predetermined interval without coming into contact with each other when the connection body 1B is assembled, for the prevention of short circuit between the first terminals 20B and the first metal plates 30B. In this example, there are the gaps L2 in the longitudinal direction (the x-axis direction in FIG. 14(c)) of the connection body 1B and there are the gaps W2 in the width direction (the y-axis direction in FIG. 15(b)) of the connection body 1B.

(3) Each of the harnesses 60B is mounted so that the surface 61Ba3 is abutted on the end portion (the first contact surface 20Bc) on the upper side (the +z direction side in FIG. 16) of the first contact portion 20Ba.

(4) The first pressing portions 50Ba are mounted on the respective surfaces 61Ba4 of the second contact portions 61Ba.

(5) The second metal plate 70B is mounted on the second insulating plate 50B. This mounting is performed so that the first pressing portion 50Ba and the second pressing portion 70Ba are abutted on each other.

(6) The bolt 80B is inserted through the fourth bolt insertion portion 70Bb, the third bolt insertion portion 50Bb, the second bolt insertion portion 10Bb, and the first bolt insertion portion 30Bb from the second metal plate 70B side, the nut 40B is attached to the bolt 80B from the first metal plate 30B side, and the bolt 80B and the nut 40B are fastened.

The connection body 1B is configured so that the first bolt insertion portion 30Bb faces the second bolt insertion portion 10Bb, the second bolt insertion portion 10Bb faces the third bolt insertion portion 50Bb, and the third bolt insertion portion 50Bb faces the fourth bolt insertion portion 70Bb when the connection body 1B is assembled. Namely, the relative positional relationship between the first bolt insertion portion 30Bb, the second bolt insertion portion 10Bb, the third bolt insertion portion 50Bb, and the fourth bolt insertion portion 70Bb is a positional relationship which allows fastening by insertion of the bolt 80B. In the connection body 1B of the present disclosure, the fastening by the bolt 80B makes the first contact portions 20Ba and the respective second contact portions 61Ba conductive.

In other words, the relative positional relationship between the first bolt insertion portion 30Bb, the second bolt insertion portion 10Bb, the third bolt insertion portion 50Bb, and the fourth bolt insertion portion 70Bb is as follows. Namely, the first bolt insertion portion 30Bb, the second bolt insertion portion 10Bb, the third bolt insertion portion 50Bb, and the fourth bolt insertion portion 70Bb are formed in the positional relationship which allows fastening by insertion of a single bolt (the bolt 80B) in the second state in which the base portions 20Bb of the first terminals 20B are inserted into the respective third cutout portions 31Ba, the second terminals 61B are mounted on the respective end portions of the first contact portions 20Ba, the first pressing portions 50Ba are mounted on the respective end portions of the second contact portions 61Ba, and the second pressing portions 70Ba are mounted on the respective first pressing portions 50Ba in the first state in which the first insulating plate 10B is mounted on the first metal plate 30B with the pair of first cutout portions 30Ba and the second cutout portions 10Ba facing each other, and this fastening makes the first contact portions 20Ba and the respective second contact portions 61Ba conductive.

The connection body 1B of the present embodiment is configured to directly join the first terminals 20B with the second terminals 61B using the first metal plate 30B, the first insulating plate 10B, the second insulating plate 50B, and the second metal plate 70B. The direct joining can be performed by a single bolt 80B (and the nut 40B). Accordingly, this configuration does not require, for example, a separate metal fitting such as the second terminal metal fitting body 86 of Patent Literature 1, which is joined to terminals to join terminals. Further, the connection body 1B is configured so that the first terminals 20B and the second terminals 61B are directly joined to each other to be conductive. Patent Literature 1 employs the configuration joining by the clip spring 88 serving as an elastic member. The joining by springs requires plating to reduce contact resistance. The connection body 1B can achieve conduction between terminals by direct joining between the first terminals 20B and the second terminals 61B. Further, the connection body 1B can obtain high contact force by bolt fastening force and can accordingly significantly reduce the electrical resistance, eliminating necessity of plating. As a result, also in the connection body 1B of the present disclosure, increase in the number of components can be suppressed and connection that can withstand large currents can be achieved.

The harnesses 60B are mounted so that the surfaces 61Ba3 are abutted on the end portions (the first contact surfaces 20Bc) on the upper side (the +z direction side in FIG. 14) of the first contact portions 20Ba in the present embodiment, but the connection between the first contact portions 20Ba and the second contact portions 61Ba is not limited to this. For example, the harnesses 60B may be configured so that the harnesses 60B are rotated by 90 degrees around the longitudinal direction (the x-axis direction in FIG. 14) of the harnesses 60B as an axis, and the surfaces 61Ba1 or the surfaces 61Ba2 are abutted on the end portions (the first contact surfaces 20Bc) on the upper side of the first contact portions 20Ba. Alternatively, the first terminals 20B may be configured so that the first terminals 20B are rotated by 90 degrees around the longitudinal direction (the x-axis direction in FIG. 15) of the harnesses 60B as an axis and the surfaces 61Ba3 (see FIG. 14) are abutted on surfaces 20Ba1 (or surfaces 20Ba2), forming a flat plate shape, of the first terminals 20B. In these configurations, the shapes of the first insulating plate 10B, the first metal plate 30B, the second insulating plate 50B, and the second metal plate 70B are to be changed as appropriate while ensuring strength and insulation property in accordance with the arrangement positions of the shapes.

Thus, in the connection body 1B of the present embodiment, the pair of first contact portions 20Ba and the pair of second contact portions 61Ba may be provided so that at least one of the pair of first contact portions 20Ba and the pair of second contact portions 61Ba are raised “along” the insertion direction of the bolt 80B or may be provided so that at least one of the pair of first contact portions 20Ba and the pair of second contact portions 61Ba are raised “with respect to” the insertion direction of the bolt 80B, as long as the first contact portions 20Ba and the second contact portions 61Ba can be directly joined to each other.

### Modification of Second Embodiment

In the second embodiment, the first metal plate 30B does not have to be used as long as the first insulating plate 10B can be formed to have rigidity equal to or greater than that of the first terminal 20B and the first metal plate 30B. The second metal plate 70B does not have to be used as long as the second insulating plate 50B can be formed to have rigidity equal to or greater than that of the second terminal 61B and the second metal plate 70B.

In this configuration, the method for connecting the connection body 1B can be performed, for example, by assembling the connection body 1B in accordance with processes (1) to (5) below. However, the processes in the method for connecting the connection body 1B of this modification are not limited to the processes described below.

(1) The first insulating plate 10B, the first terminals 20B, the second terminals 61B, and the second insulating plate 50B are prepared.

(2) The base portions 20Bb of the first terminals 20B are inserted into the respective second cutout portions 10Ba.

(3) The second terminals 61B are mounted on the respective end portions (the first contact surfaces 20Bc) of the first contact portions 20Ba.

(4) The first pressing portions 50Ba are mounted on the respective end portions (the surfaces 61Ba4) of the second contact portions 61Ba.

(5) The bolt 80B is inserted through the third bolt insertion portion 50Bb and the second bolt insertion portion 10Bb from the second insulating plate 50B side, the nut 40B is attached to the bolt 80B from the first insulating plate 10B side, and the bolt 80B and the nut 40B are fastened.

In the first insulating plate 10B and the second insulating plate 50B of the above-mentioned modification, if only the first insulating plate 10B has high rigidity, the second metal plate 70B may be prepared on the second insulating plate 50B side. If only the second insulating plate 50B has high rigidity, the first metal plate 30B may be prepared on the first insulating plate 10B side.

The first embodiment, the second embodiment, and the modification of the second embodiment have been described above. Although the present disclosure mentions copper as an actual conductive member, stainless steel as a metal, and resin or glass epoxy resin as an insulator, not limited to the specific materials illustrated in the examples, the connection body of the present disclosure may use other materials within the scope of the conductive members, metal members, insulating members, and the like described in the present disclosure. In addition, it goes without saying that the above-described connection body can be modified as appropriate without departing from the spirit and scope of the present disclosure.

The foregoing description of the embodiments of the invention has been presented for the purpose of illustration and description. It is not intended to be exhaustive and to limit the invention to the precise form disclosed. Modifications or variations are possible in light of the above teaching. The embodiment was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A connection body comprising:
a first insulating plate which has a pair of second cutout portions formed on both ends and a second bolt insertion portion formed between the pair of second cutout portions;
a pair of first terminals which have base portions having flat plate shapes to be able to be inserted into the second cutout portions, and first contact portions, the first contact portions being connected with one ends of the base portions in a longitudinal direction and having flat plate shapes extended to have a width, the width being greater than a width of the second cutout portions, on both sides in a width direction of the base portions;
a pair of second terminals which have second contact portions having flat plate shapes to be able to be mounted on end portions, the end portions being on an opposite side to the base portions, of the first contact portions in the pair of first terminals; and
a second insulating plate which has a pair of first pressing portions being able to be mounted on surfaces, the surfaces being on an opposite side to the first terminals, of the second contact portions in the pair of second terminals, a first coupling portion coupling the pair of first pressing portions, and a third bolt insertion portion formed in the first coupling portion, wherein
a positional relationship between the second bolt insertion portion and the third bolt insertion portion is a positional relationship which allows fastening by insertion of a single bolt in a state in which the base portions of the first terminals are inserted into the respective second cutout portions, the second terminals are mounted on the respective end portions of the first contact portions, and the first pressing portions are mounted on respective end portions of the second contact portions, and the fastening makes the first contact portions and the respective second contact portions conductive.

2. A connection body comprising:
a first metal plate which has a pair of first cutout portions formed on both ends and a first bolt insertion portion formed between the pair of first cutout portions;
a first insulating plate which has a pair of second cutout portions formed on positions facing the pair of first cutout portions when the first insulating plate is mounted on the first metal plate, and a second bolt insertion portion formed between the pair of second cutout portions;
a pair of first terminals which have base portions having flat plate shapes to be able to be inserted into third cutout portions, the third cutout portions being formed by the first cutout portions and the second cutout portions, in a first state in which the first insulating plate is mounted on the first metal plate in a manner to make the pair of first cutout portions and the pair of second cutout portions face each other, and first contact portions, the first contact portions being connected with one ends of the base portions in a longitudinal direction and having flat plate shapes extended to have a width, the width being greater than a width of the third cutout portions, on both sides in a width direction of the base portions;
a pair of second terminals which have second contact portions having flat plate shapes to be able to be mounted on end portions, the end portions being on an opposite side to the base portions, of the first contact portions in the pair of first terminals;
a second insulating plate which has a pair of first pressing portions being able to be mounted on surfaces, the surfaces being on an opposite side to the first terminals, of the second contact portions in the pair of second terminals, a first coupling portion coupling the pair of first pressing portions, and a third bolt insertion portion formed in the first coupling portion; and
a second metal plate which has a pair of second pressing portions being able to be mounted on the first pressing portions, the first pressing portions being on an opposite side to the second contact portions, in the pair of first pressing portions, a second coupling portion coupling the pair of second pressing portions, and a fourth bolt insertion portion formed in the second coupling portion, wherein
a positional relationship between the first bolt insertion portion, the second bolt insertion portion, the third bolt insertion portion, and the fourth bolt insertion portion is a positional relationship which allows fastening by insertion of a single bolt in a second state in which the base portions of the first terminals are inserted into the respective third cutout portions, the second terminals are mounted on the respective end portions of the first contact portions, the first pressing portions are mounted on respective end portions of the second contact portions, and the second pressing portions are mounted on the respective first pressing portions in the first state, and the fastening makes the first contact portions and the respective second contact portions conductive.

3. The connection body according to claim 2, wherein the first terminals and the first metal plate have a predetermined interval therebetween without coming into contact with each other.

4. A connection body comprising:
a header; and
a plug harness which is fitted to the header, wherein
the header includes
a first housing which is made of an insulating material and has a pair of first hole portions formed in parallel with each other in a penetrating manner and a second bolt insertion portion formed between the pair of first hole portions in parallel with the pair of first hole portions,
a pair of first terminals which have first contact surfaces on one ends thereof and have first contact portions having flat plate shapes to be able to be inserted into the respective first hole portions from a first contact surface side, and
a first holding member which is made of an insulating material and has a pair of first pressing portions for pressing each of the first terminals from a surface side opposite to the first contact surfaces to the first contact surface side in a first state in which the first terminals are inserted into the respective first hole portions from the first contact surfaces, a connecting portion for connecting the pair of first pressing portions to each other, and a first bolt insertion portion formed in the connecting portion,
the plug harness includes
a second housing which is made of an insulating material, can be fitted to the first housing, and has a pair of second hole portions formed in parallel so that at least portions thereof face the first contact surfaces when the plug harness is fitted to the header, an opening portion formed so as to encompass a portion of each of the second hole portions and open in one direction of a first axis, the first axis intersecting with a hole direction of the second hole portions, and a third bolt insertion portion formed between the pair of second hole portions in parallel with the first axis,
a pair of second terminals which have second contact portions on one ends thereof, the second contact portions having flat plate shapes to be able to be inserted into the respective second hole portions, and
a second holding member which has a second pressing portion used for pressing a predetermined region of a first surface in the one direction, the first surface being an outer surface of the second housing and having the third bolt insertion portion formed therein, and a fourth bolt insertion portion penetrating through the second pressing portion, and
a positional relationship between the first bolt insertion portion, the second bolt insertion portion, the third bolt insertion portion, and the fourth bolt insertion portion is a positional relationship which allows fastening by insertion of a single bolt in a second state in which the pair of first pressing portions are allowed to press the respective first terminals, the pair of second terminals are inserted into the respective second hole portions provided in pair, the first housing and the second housing are fitted to each other in a manner in which each of the first hole portions and the opening portion face each other, the second pressing portion of the second holding member is mounted on the predetermined region, and the first pressing portions of the first holding member are allowed to be abutted on respective surfaces, the surfaces being on an opposite side to the first contact surfaces of the first terminals, in the first state, and the fastening makes the first contact portions and the respective second contact portions conductive.

5. The connection body according to claim 4, wherein the pair of first contact portions and the pair of second contact portions are provided so that at least one of the pair of first contact portions and the pair of second contact portions are raised along an insertion direction of the bolt.

6. The connection body according to claim 4, wherein each of the pair of second terminals is composed of a plurality of core wires, and each of the second contact portions is formed by performing compaction processing to the core wires.

7. The connection body according to claim 4, further comprising:
a shutter member which has a pair of shutter portions, the pair of shutter portions covering respective peripheries of one end portions of the first contact portions in a manner to expose the end portions, wherein
each of the first contact portions is provided to be in an upright position with respect to the first holding member.

8. The connection body according to claim 7, wherein
the shutter member has a connecting portion connecting the pair of shutter portions and a fifth bolt insertion portion formed in the connecting portion and allowing insertion of the bolt therethrough,
the connection body further includes an elastic member which is provided between the first holding member and the connecting portion, and
before the fastening is completed, the shutter member is pressed by the elastic member and end portions of the shutter portions are accordingly positioned on a pressing direction side of the first pressing portions relative to the end portions of the first contact portions, and from before completion of the fastening to the completion, the shutter member moves to a position where the end portions of the first contact portions are allowed to be conduct with the second contact portions.

9. The connection body according to claim 8, wherein a waterproof member is provided on a second holding member side on the third bolt insertion portion.

10. A method for connecting a connection body, the method comprising:
preparing
a first insulating plate which has a pair of second cutout portions formed on both ends and a second bolt insertion portion formed between the pair of second cutout portions,
a pair of first terminals which have base portions having flat plate shapes to be able to be inserted into the second cutout portions, and first contact portions, the first contact portions being connected with one ends of the base portions in a longitudinal direction and having flat plate shapes extended to have a width, the width being greater than a width of the second cutout portions, on both sides in a width direction of the base portions,
a pair of second terminals which have second contact portions having flat plate shapes to be able to be mounted on end portions, the end portions being on an opposite side to the base portions, of the first contact portions in the pair of first terminals, and
a second insulating plate which has a pair of first pressing portions being able to be mounted on surfaces, the surfaces being on an opposite side to the first terminals, of the second contact portions in the pair of second terminals, a first coupling portion coupling the pair of first pressing portions, and a third bolt insertion portion formed in the first coupling portion;
inserting the base portions of the first terminals into the respective second cutout portions;
mounting the second terminals on the respective end portions of the first contact portions;
mounting the first pressing portions on respective end portions of the second contact portions; and
inserting a single bolt from the third bolt insertion portion to the second bolt insertion portion so as to make the first contact portions and the respective second contact portions conductive.

11. A method for connecting a connection body, the method comprising:
preparing
a first housing which is made of an insulating material and has a pair of first hole portions formed in parallel with each other in a penetrating manner and a second bolt insertion portion formed between the pair of first hole portions in parallel with the pair of first hole portions,
a pair of first terminals which have first contact surfaces on one ends thereof and have first contact portions having flat plate shapes to be able to be inserted into the respective first hole portions from the first contact surfaces,
a first holding member which is made of an insulating material and has a pair of first pressing portions for pressing each of the first terminals from a surface side opposite to the first contact surfaces to a first contact surface side in a first state in which the first terminals are inserted into the respective first hole portions from the first contact surfaces, a connecting portion for connecting the pair of first pressing portions to each other, and a first bolt insertion portion formed in the connecting portion,
a second housing which is made of an insulating material and has a pair of second hole portions formed in parallel, an opening portion formed so as to encompass a portion of each of the second hole portions and open in a first direction, the first direction intersecting with a hole direction of the second hole portions, and a third bolt insertion portion formed between the pair of second hole portions in the first direction,
a pair of second terminals which have second contact portions on one ends thereof, the second contact portions having flat plate shapes to be able to be inserted into the respective second hole portions, and
a second holding member which has a second pressing portion used for pressing a predetermined region of a first surface to a second hole portion side, the first surface being an outer surface of the second housing and having the third bolt insertion portion formed therein, and a fourth bolt insertion portion penetrating through the second pressing portion;
fitting the first housing and the second housing to each other in a manner in which each of the first hole portions and the opening portion face each other, in the first state;
mounting the second pressing portion of the second holding member on the first surface;
joining the first pressing portions of the first holding member on respective surfaces of the first terminals; and
inserting a single bolt through the first bolt insertion portion, the second bolt insertion portion, the third bolt insertion portion, and the fourth bolt insertion portion so as to make the first contact portions and the respective second contact portions conductive.
